(19) United States
(12) Patent Application Publication
(10) Pub. No.: US 2026/0058375 A1
(43) Pub. Date: Feb. 26, 2026

(54) Controller Configured to Improve DC Power Consumption of Phased Array Antennas

(71) Applicant: CesiumAstro, Inc., Austin, TX (US)

(72) Inventors: Danilo Dadic, Austin, TX (US); Thomas Magesacher, Austin, TX (US)

(73) Assignee: CesiumAstro, Inc., Austin, TX (US)

(21) Appl. No.: 16/711,283

(22) Filed: Dec. 11, 2019

Related U.S. Application Data
(60) Provisional application No. 62/778,209, filed on Dec. 11, 2018.

(51) Int. Cl. H01Q 3/36; H03F 3/24

(52) U.S. Cl. CPC H01Q 21/22

(57) ABSTRACT

The required equivalent isotropic radiated power of a phased array can vary rapidly due to changes of channel conditions, link properties, communication distance, or mode of operation. Maintaining maximum efficiency of a phased array antenna over the entire range of required equivalent isotropic radiated power levels is challenging but highly desirable. An array controller is disclosed that computes the optimal set of power amplifiers and beamformer elements to be activated in order to achieve the highest possible efficiency, or equivalently, the lower possible power consumption for the equivalent isotropic radiated power while maintaining the selected beam pattern.

### CROSS-REFERENCE TO RELATED APPLICATION(S)

The present disclosure is a non-provisional of and claims priority to U.S. Provisional Application No. 62/778,209 filed on Dec. 11, 2018 and entitled “Controller Configured to Improve DC Power Consumption of Phased Array”, which is incorporated herein by reference in its entirety.

### FIELD

The present disclosure is generally related to power consumption in phased array antennas, and more particularly, to a controller configured to improve or optimize power consumption of a phased array antenna.

### BACKGROUND

Active phased arrays allow for electronic steering of radiated power to form transmit beams. A major challenge is power consumption, which is dominated by the direct current (DC) power consumed by the power amplifiers and by the beamforming network. A key performance indicator of a phased array is its efficiency defined as the ratio of radio frequency (RF) output power to consumed DC power.

### SUMMARY

In many applications, the required Equivalent Isotropic Radiated Power (EIRP), defined as the product between radiated RF power and phased array gain, varies during operation. This can be caused, for example, by changing channel conditions, by variation in the distance between the transmitter and the receiver, or by changes in the receive antenna gain when switching to a different user or users after a beam-direction change. In addition, efficiency of the power amplifiers, defined as the ratio of amplifier's output RF power to the DC power consumed by the amplifier, varies during operation in many applications. This can be caused, for example, by changes in temperature or by changes in signal modulation. This invention addresses dynamic efficiency optimization of active phased arrays by means of an array controller, which increases or even maximizes the efficiency of the array when required ERIP or amplifier efficiency varies with time.

Embodiments of a wideband active-phased array may include antenna elements, power and low-noise amplifiers, beamformer, and point-of-load power converters, which may provide electronic steering in a plug-and-play module. The active phased-array may have a low mass and low profile relative to convention phased array components, which make it well-suited for space constrained systems, such as low-earth-orbit (LEO) satellites, launch vehicles, and other airborne platforms. The active phased-array may provide wide steerability (plus or minus 60 degrees) with a built-in control module to allow for tracking without mechanical movements and at low user elevation angles. In some implementations, the active phased array may be constructed of tiles, each of which may act either as a standalone unit or as a building block for a larger array. In one implementation, the active phased array tile may be approximately 9 cm by 9 cm and can operate in Ku-band with right-hand circular polarization (RHCP) or left-hand circular polarization (LHCP).

In some embodiments, a phased array may include an array of antenna elements, beamformer circuits including an input or inputs coupled to the output of signal source or a signal conditioner and including an output coupled to an input of a power amplifier array, and the power amplifier array including an input coupled to the output of the beamformer circuits and including an output coupled to an input of the antenna array. The antenna system may further include a controller coupled to the beamformer circuits and to the power amplifiers. The controller may selectively activate and configure one or more beamformer circuits such that the array efficiency is maximized for the currently required EIRP or current amplifier efficiency. The controller may be further configured to selectively activate one or more power amplifiers of the power amplifier array such that the array efficiency is maximized for the currently required EIRP or current amplifier efficiency.

In some embodiments, a system may include a controller coupled to one or more of a beamformer circuit or a power amplifier array. The controller may include computation unit to determine on/off control vectors for one or more of beamforming elements of the beamformer circuit or power amplifiers of power amplifier array. The controller may include a first output and a second output. The first output may be configured to provide an on/off-control vector configured to selectively activate or deactivate one or more of the beamforming elements. The second output may be configured to provide an on/off-control vector to selectively activate or deactivate one or more of the power amplifiers.

In other embodiments, a system may include a controller coupled to a beamformer circuit and a power amplifier array. The controller may include a computation unit to determine a first control vectors and a second control vector. The controller may also include a first output and a second output. The first output may provide the first control vector to the beamformer circuit to selectively activate or deactivate one or more beamforming elements. The second output may provide an on/off-control vector to selectively activate or deactivate one or more of the power amplifiers.

In still other embodiments, a system may include a controller configured to determine varying amplifier efficiency, determine one or more beamforming elements, and selectively activate the one or more beamforming elements within operational constraints of the power amplifier array to reduce DC power consumption of a phased array.

### BRIEF DESCRIPTION OF THE DRAWINGS

FIG. 1 is a graph of dynamic power consumption of an active phased array system showing the DC power consumption versus the number of activate elements in the array, in accordance with certain embodiments of the present disclosure.

FIG. 2 is a block diagram of a transmit circuit of an active phased array system for dynamic power optimization of an active phased array system, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Previous work on controlling beamforming elements (often called amplitude tapering or power tapering) appears somewhat similar but focused on beam-shape optimization instead of power minimization. Such systems did not power down inactive beamforming circuits and amplifiers nor did such systems make related decisions based on the required EIRP or current amplifier efficiency with the aim of phased array efficiency maximization.

The required equivalent isotropic radiated power of a phased array can vary rapidly due to changes of channel conditions, link properties, communication distance, or mode of operation. Maintaining maximum efficiency of a phased array antenna over the entire range of required equivalent isotropic radiated power levels is challenging but highly desirable. An array controller is disclosed below that may determine the optimal set of power amplifiers and beamformer elements to be activated in order to achieve the highest possible efficiency, or equivalently, the lower possible power consumption for the equivalent isotropic radiated power while maintaining the selected beam pattern.

Embodiments of a controller are disclosed below that can be used in scenarios where a varying EIRP is needed or varying amplifier efficiency is present. In general, the controller can be fed input parameters or constraints, such as a required EIRP, current output RF power of amplifiers, current consumed DC power of amplifiers, current consumed DC power of the beamformer, other data, or any combination thereof. From these input parameters, the controller may calculate the optimum RF output power of the amplifiers and the optimum number of active elements, the product of which may equal or approximate the required EIRP. Furthermore, the controller may be configured to ensure that the optimum solution does not violate operational constraints. For example, an operational constraint may be the minimum (or maximum) beamwidth, which may depend on the number of active elements. In one embodiment, the control circuit may be included within a housing of a satellite to optimize phased array power consumption as the required EIRP varies due to varying path loss or different ground stations with antennas of varying quality. In another embodiment, the controller may be included within an aerial or a ground vehicle to optimize phased array power consumption as the required EIRP varies due to varying distance between the vehicle and a ground station with the receive antenna or to varying distance between the vehicle and another vehicle with the receive antenna.

In some embodiments, the changes in efficiency and EIRP may lead to a change in the optimum tradeoff between antenna gain (due to the power consumed in the beamforming network) and RF output power (due to the power consumed by the amplifiers), which is a function of the number of active elements for a given EIRP. This dynamic tradeoff can be leveraged for minimization of the DC power consumption. The relationship can be expressed according to the following equation:

$${P}_{DC} = \frac{{P}_{EIRP}}{N {e}_{PA}} + {P}_{BFNchannel} N in Watts , \qquad ( 1 )$$

In Equation, 1, the variable (P_{DC}) represents the total DC power for a given effective isotropic radiated power (P_{EIRP}). Further, the variable (e_{PA}) may represent the efficiency of the power amplifiers. The variable (N) may represent the number of elements in the active phased array. Further, the variable (P_{BFNchannel}) may represent the necessary DC power in Watts for a beamforming channel.

In Equation 1, the first term in the sum represents the total DC power necessary for all power amplifiers, while the second term represents the total DC power necessary for the beamforming network. The sum represents the total DC power in a system for a given EIRP, a given efficiency, and a given number of elements. Equation 1 holds for practical arrays (e.g., arrays including hundreds of elements), where the amplifiers and beamforming network dominate the total DC power budget.

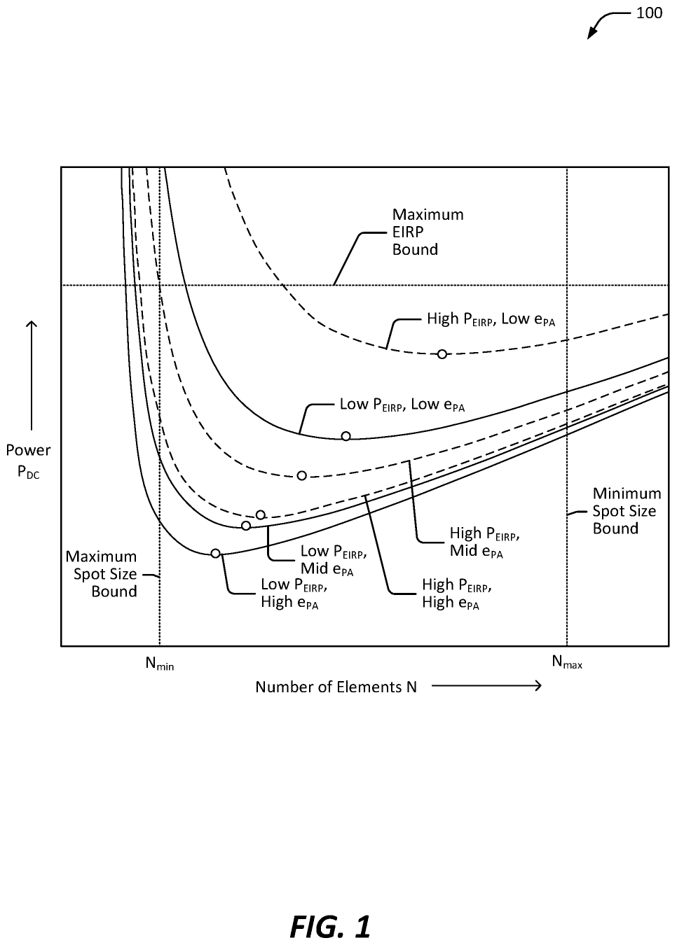

FIG. 1 is a graph 100 of dynamic power consumption of an active phased array system showing the power consumption versus the number of elements in the array, in accordance with certain embodiments of the present disclosure. The graph shows a family of P_{DC} curves as a function of N for varying EIRP and e_{PA} (i.e. modulation). For each curve (or equivalently, for each combination of EIRP and e_{PA}), there is an optimal number of elements resulting in the minimum required power consumption (indicated by circles in FIG. 1). In certain embodiments, the overall optimization space (indicated by the shaded area in FIG. 1) may be constrained by operating conditions such as the maximum desirable spot size (or maximum desirable sidelobes) at Nₘᵢₙ and the maximum number of elements in the aperture or minimum desirable spot size at Nₘₐₓ.

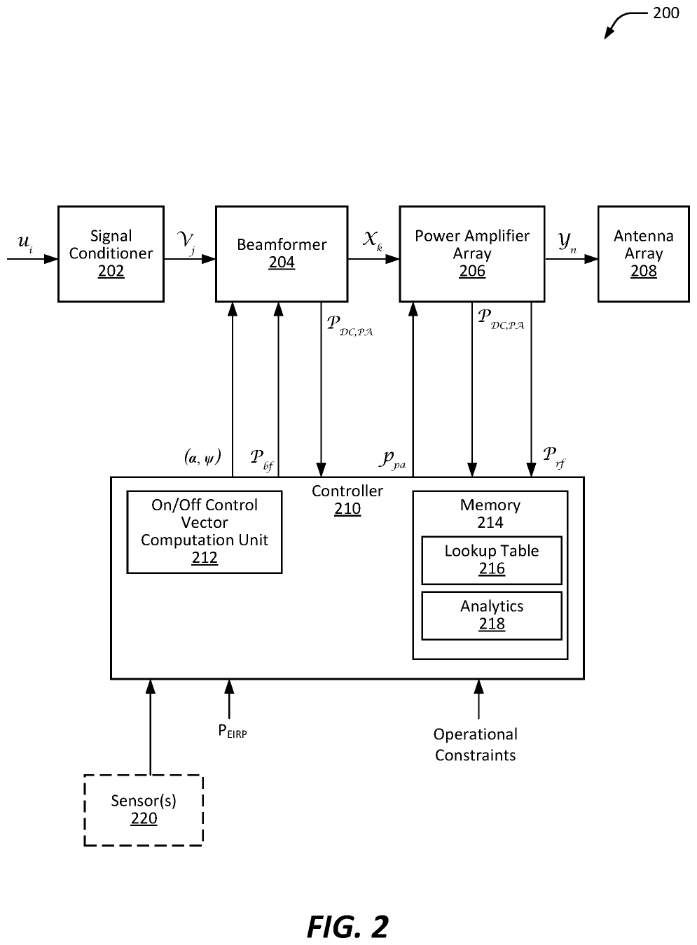

In the illustrated example of FIG. 1, it can be seen that for each combination of EIRP and e_{PA} there exists a power-consumption minimum that can be achieved by selecting the proper number of elements. To leverage this effect, the controller (controller 210 in FIG. 2) may be configured to select a number of elements to achieve a selected total DC power. For example, during operation, the array power dissipation may be kept at or near minimum by dynamically activating and deactivating beamforming circuits and amplifiers for individual array elements and by adjusting the biasing of the power amplifiers of the remaining elements while keeping control over the resulting beam shape changes and providing the required total RF output power to achieve the required EIRP. The controller may also set the element weighing factor to maintain a selected beam shape while reducing or even minimizing the power consumption. The controller may also consider current operational bounds when dynamically activating and deactivating beamforming circuits and amplifiers for individual array elements and adjusting the biasing of the power amplifiers of the remaining elements. Using the current operational bounds as a constraint is important because the power-consumption minimum may lie outside of the current operational bounds.

FIG. 2 is a block diagram of a transmit circuit 200 of an active phased array system for dynamic power optimization of an active phased array system, in accordance with certain embodiments of the present disclosure. The transmit circuit 200 may be configured to work with an array antenna with N elements. In some embodiments, the transmit circuit 200 can prepare several signal streams uᵢ for transmission using the signal conditioner 202. The signal conditioner 202, depending on the system, may perform encoding, modulation, predistortion, allocation in frequency to the selected channel band, other signal grooming functions, or any combination thereof. The signal conditioner 202 provides groomed signal streams vⱼ to the beamformer 204.

The beamformer 204 may take the streams vⱼ and generate signals streams xₖ based on the weighting information (α, ψ) received from the array controller 210, which signals xₖ may be provided to a power amplifier array 206. The weighting information (α and ψ) can be a vector containing amplitude and phase factors, respectively. The beamformer 204 may also receive an on/off-control vector (p_{bf}) that can be used to turn on/off selected beam-forming elements.

The power amplifier array 206 may receive the signals xx from the beamformer 204 and on/off control vector (pₚₐ) from the array controller 210. The power amplifier array 206 may provide amplified signals y, to the antenna array 208.

The controller 210 may include a vector computation unit 212. The vector computation unit 212 may be implemented as a general-purpose computer processor configured to execute processor-readable instructions, which may be stored in a memory 214 or may be stored in a Read-Only Memory (ROM) that is part of the general-purpose computer processor. Alternatively, the vector computation unit 212 may be implemented as field programmable gate array (FPGA) or other programmable circuit.

The controller 210 may include the memory 214, which may include a non-volatile memory devices, such as a hard disc drive, a solid state drive, and so on. The memory 214 may store processor-readable instructions as well as data. In some implementations, the memory 214 may store a lookup table 216, which may include power curves, such as those depicted in FIG. 1, which may be processed to identify a “sweet spot” indicative of an optimal number of elements to achieve a selected power level.

The memory 214 may also include analytics 218, which may be executed by the computation unit 212 to perform lookups in the lookup table 216 to determine which power amplifiers of the power amplifier array 206 and which beamformers of the beamformer 204 to activate or deactivate to achieve a selected isotropic radiated power and to maintain a selected beam pattern. Alternatively, the analytics 218 may cause the computation unit 212 to determine one or more on/off power vectors directly, for controlling the beamformer 204, the power amplifier array 206, or both.

In some implementations, the controller 210 may be configured to receive data from one or more sensors 220. The sensor data may be indicative of received signal strength, power levels, other data, or any combination thereof.

In some implementations, the controller 210 may be configured to receive the required EIRP as an input. Additionally, the controller 210 may be configured to also receive all or any of the following: current operational constraints, measured RF output power of each amplifier (P_{rf}), measured DC power consumption for amplifiers (P_{DC,PA}), and the measured DC power consumption (P_{DC,BF}) of the beamformer 204. These optional inputs may be used in applications where the values of these inputs cannot be stored within the controller, such as in the cases where the values of these inputs vary with time.

In some implementations, the EIRP may be provided by the application layer of the local receiver (for example, derived from location information). As another example, the EIRP may be provided from the far-end transceiver (the phased-array system's counterpart it is talking to) such as a ground station in a satellite system. The controller 210 may be configured to compute the on/off-control vector (pₚₐ) used to turn on/off selected power amplifiers, the on/off-control vector (p_{bf}) used to turn on/off selected beam-forming elements, and the control-vector pair (α, ψ) with gain and phase information for the elements that are turned on (i.e., the active elements).

The controller 210 may compute the optimal number of antenna elements to be turned on that can reduce or even minimize the overall power consumption of the system. Furthermore, controller 210 may compute the set of power amplifiers of the power amplifier array 206 to be activated as well as the corresponding gain and phase settings to use so that the specified spatial radiation (beam shape) requirements are fulfilled. Furthermore, the array controller 210 can monitor the resulting power consumption (P_{DC}) and the “health” of the individual power amplifiers by comparing the desired (computed) output power of each amplifier to actual measurements (P_{rf}).

In conjunction with the systems and methods described above with respect to FIGS. 1 and 2, embodiments of an antenna system may include an antenna array, a beamformer circuit including inputs and outputs, and a power amplifier array including inputs coupled to the output of the beamformer circuits and including outputs coupled to the inputs of the antenna array. The antenna system may further include a controller coupled to the beamformer circuit and the power amplifier array. The controller may be configured to selectively activate and configure one or more beamforming elements of the beamformer circuit. The controller may be further configured to selectively activate one or more power amplifiers of the power amplifier array.

Although the present invention has been described with reference to preferred embodiments, workers skilled in the art will recognize that changes may be made in form and detail without departing from the scope of the invention.

What is claimed is:

1. A system comprising:
a controller coupled to one or more of a beamformer circuit or a power amplifier array, the controller comprising:
a computation unit to determine on/off control vectors for one or more of beamforming elements of the beamformer circuit or power amplifiers of power amplifier array;
a first output configured to provide an on/off-control vector configured to selectively activate or deactivate one or more of the beamforming elements;
a second output configured to provide an on/off-control vector to selectively activate or deactivate one or more of the power amplifiers.

2. The system of claim 1, wherein the controller is configured to:
determine varying effective isotropic radiated power (EIRP);
determine one or more beamforming elements; and
selectively activate the one or more beamforming elements within operational constraints of the power amplifier array when to reduce DC power consumption of a phased array.

3. The system of claim 1, wherein the controller is configured to:
determine varying amplifier efficiency;
determine one or more beamforming elements; and
selectively activate the one or more beamforming elements within operational constraints of the power amplifier array to reduce DC power consumption of a phased array.

4. The system of claim 1, wherein the controller further comprises a third output configured to provide, to the beamformer circuit, a control-vector pair (α, ψ) with gain and phase information for the one or more beamforming elements that are activated.

5. The system of claim 1, wherein the controller further comprises an input configured to receive an effective isotropic radiated power (EIRP) for a phased array antenna.

6. The system of claim 4, wherein the controller further comprises a second input configured to receive current operational constraints for the active phased array;

7. The system of claim 6, wherein the controller further comprises:
a third input configured to receive measured RF output power for each element of the active phased antenna array;
a fourth input configured to receive measured consumed DC power of the power amplifier array; and
a fifth input configured to receive measured consumed DC power of the beamformer.

8. The system of claim 1, further comprising:
a signal controller including an input to receive a signal and including an output;
the beamformer including a first input coupled to the output of the signal controller, a second input coupled to the controller, a third input coupled to the controller, a first output coupled to the controller, and one or more second outputs;
the power amplifier array including one or more inputs coupled to the one or more second outputs of the beamformer, the power amplifier array including a second input coupled to the controller, the power amplifier further including a first output coupled to the controller, a second output coupled to the controller, and one or more third outputs to provide one or more signals to an input of an antenna array.

9. The system of claim 1, wherein the controller is configured to determine a first set of power amplifiers to be activated and a second set of beamformer elements to be activated to achieve a selected efficiency.

10. The system of claim 9, wherein the selected efficiency includes a selected power consumption level of a plurality of power consumption levels to achieve a selected isotropic radiated power and to maintain a selected beam pattern.

11. A system comprising:
a controller coupled to a beamformer circuit and a power amplifier array, the controller comprising:
a computation unit to determine a first control vectors and a second control vector;
a first output to provide the first control vector to the beamformer circuit to selectively activate or deactivate one or more beamforming elements;
a second output configured to provide an on/off-control vector to selectively activate or deactivate one or more of the power amplifiers.

12. The system of claim 11, wherein the controller is configured to:
determine varying effective isotropic radiated power (EIRP);
determine one or more beamforming elements; and
selectively activate the one or more beamforming elements within operational constraints of the power amplifier array when to reduce DC power consumption of a phased array.

13. The system of claim 11, wherein the controller is configured to:
determine varying amplifier efficiency;
determine one or more beamforming elements; and
selectively activate the one or more beamforming elements within operational constraints of the power amplifier array to reduce DC power consumption of a phased array.

14. The system of claim 11, wherein the controller further comprises a third output configured to provide, to the beamformer circuit, a control-vector pair (α, ψ) with gain and phase information for the one or more beamforming elements that are activated.

15. The system of claim 11, wherein the controller further comprises an input configured to receive an effective isotropic radiated power (EIRP) for a phased array antenna.

16. The system of claim 15, wherein the controller further comprises a second input configured to receive current operational constraints for the active phased array;

17. The system of claim 16, wherein the controller further comprises:
a third input configured to receive measured RF output power for each element of the active phased antenna array;
a fourth input configured to receive measured consumed DC power of the power amplifier array; and
a fifth input configured to receive measured consumed DC power of the beamformer.

18. The system of claim 11, further comprising:
a signal controller including an input to receive a signal and including an output;
a beamformer including a first input coupled to the output of the signal controller, a second input coupled to the controller, a third input coupled to the controller, a first output coupled to the controller, and one or more second outputs;
a power amplifier array including one or more inputs coupled to the one or more second outputs of the beamformer, the power amplifier array including a second input coupled to the controller, the power amplifier further including a first output coupled to the controller, a second output coupled to the controller, and one or more third outputs to provide one or more signals to an input of an antenna array.

19. A system comprising
a controller configured to:
determine varying amplifier efficiency;
determine one or more beamforming elements; and
selectively activate the one or more beamforming elements within operational constraints of the power amplifier array to reduce DC power consumption of a phased array.

20. The system of claim 19, wherein the controller is coupled to the beamformer circuit and to a power amplifier array, the controller comprises:
a computation unit to determine a first control vectors and a second control vector;
a first output to provide the first control vector to the beamformer circuit to selectively activate or deactivate one or more beamforming elements;
a second output configured to provide an on/off-control vector to selectively activate or deactivate one or more of the power amplifiers.
